(19) United States
(12) Patent Application Publication
(10) Pub. No.: US 2024/0355031 A1
(43) Pub. Date: Oct. 24, 2024

(54) METHOD FOR PROCESSING EMOJI MESSAGE, ELECTRONIC DEVICE AND MEDIUM

(71) Applicant: BEIJING DAJIA INTERNET INFORMATION TECHNOLOGY CO., LTD., Beijing (CN)

(72) Inventor: Lixin WANG, Beijing (CN)

(21) Appl. No.: 18/240,739

(22) Filed: Aug. 31, 2023

(30) Foreign Application Priority Data
Apr. 20, 2023 (CN) 202310431458.1

(51) Int. Cl. G06T 13/80; H04L 51/10

(52) U.S. Cl. CPC G06T 13/80; H04L 51/10

(57) ABSTRACT

The disclosure provides a method for processing an emoji message, an electronic device and a medium. The method includes: in response to receiving a first emoji message, obtaining a first emoji identifier in the first emoji message; determine whether a target magic emoji corresponding to the first emoji message exists by querying a mapping table based on the first emoji identifier, in which the mapping table is configured to record mapping relations between specific emojis and magic emojis, and the magic emoji is an emoji with a specific playing effect; and in response to existence of the target magic emoji corresponding to the first emoji message, playing the target magic emoji based on a magic emoji playing strategy.

### CROSS REFERENCE TO RELATED APPLICATIONS

This application is based on and claims priority to Chinese Patent Application No. 202310431458.1, filed on Apr. 20, 2023, in the China National Intellectual Property Administration, the disclosure of which is herein incorporated by reference in their entireties.

### TECHNICAL FIELD

The disclosure relates to a field of computer technology, in particular to a method for processing an emoji message, an apparatus for processing an emoji message, an electronic device, and a medium.

### BACKGROUND

Instant messaging (IM) based chatting has become the most popular way of communication, various IM software have been developed, and service providers offer an increasingly rich set of communication service functions. In addition to an ability to send emojis between users, there are more interesting ways to play in a chatting scenario, such as an ability to play the dynamic effect of a novelty magic emoji after sending an emoji message. The dynamic effect of the magic emoji are cooler and more realistic. In the related art, the technical solution for triggering the dynamic effect of the magic emoji may be described as follows. Magic emoji material information is added to emoji information. A server sends the emoji information along with magic emoji information. A client tries to obtain the magic emoji information when receiving an emoji message, obtains the magic emoji material and renders the dynamic effect. Although this solution can obtain the magic emoji information more directly, an extra maintenance cost is required for coupling the magic emoji information in the emoji information. When playing the magic emoji according to a time sequence, it is played as soon as it is received, if there is the dynamic effect of the magic emoji currently being displayed, playing of the current magic emoji will be interrupted to play the dynamic effect of the latest magic emoji. This playing rule is relatively simple, but not user-friendly enough, for example, a scenario such as the user preferring to watch rendered synthetic magic emoji, may not be satisfied.

### SUMMARY

The disclosure provides a method for processing an emoji message, an electronic device and a medium.

According to a first aspect of embodiments of the disclosure, a method for processing an emoji message is provided. The method includes:
in response to receiving a first emoji message, obtaining a first emoji identifier in the first emoji message;
determining whether a target first-type emoji corresponding to the first emoji message exists by querying a mapping table based on the first emoji identifier, in which the mapping table is configured to record mapping relations between second-type emojis and first-type emojis, and the first-type emoji is an emoji with a specific playing effect, and the second-type emoji is an emoji capable of triggering at least one first-type emoji; and
in response to existence of the target first-type emoji corresponding to the first emoji message, playing the target first-type emoji based on a playing strategy.

According to a second aspect of the embodiments of the disclosure, an electronic device is provided. The electronic device includes: a processor and a memory for storing instructions executable by the processor. The processor is configured to execute the instructions to implement the method for processing an emoji message of any embodiment of the disclosure.

According to a third aspect of the embodiments of the disclosure, a non-transitory computer-readable storage medium having at least one computer program stored thereon is provided. When the at least one computer program is loaded and executed by a processor, the processor is caused to implement the method for processing an emoji message of any embodiment of the disclosure.

It should be understood that the above general description and the following detailed description are exemplary and explanatory only and do not limit the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure and do not constitute an undue limitation of the disclosure.

FIG. 1 is a schematic diagram of an application environment of a method for processing an emoji message according to an embodiment of the disclosure.

FIG. 2 is a flowchart of a method for processing an emoji message according to an embodiment of the disclosure.

FIG. 3A is a schematic diagram of receiving an emoji message on a terminal according to an embodiment of the disclosure.

FIG. 3B is a schematic diagram of playing a magic emoji on a terminal according to an embodiment of the disclosure.

FIG. 4A is a schematic diagram of not synthesizing a magic emoji in a method for processing an emoji message according to an embodiment of the disclosure.

FIG. 4B is a schematic diagram of synthesizing a magic emoji in a method for processing an emoji message according to an embodiment of the disclosure.

FIG. 5 illustrates a sub-flow of a method for processing an emoji message according to an embodiment of the disclosure.

FIG. 6 is a flowchart of a method for processing an emoji message according to an embodiment of the disclosure.

FIG. 7 is a block diagram of an apparatus for processing an emoji message according to an embodiment of the disclosure.

FIG. 8 is a block diagram of an electronic device according to an embodiment of the disclosure.

### DETAILED DESCRIPTION

In order to enable those skilled in the art to better understand the technical solutions of the disclosure, the technical solutions in the embodiments of the disclosure will be clearly and completely described below in combination with the accompanying drawings.

It should be noted that the terms “first”, “second”, etc. in the specification and claims of the disclosure and the accompanying drawings are used to distinguish similar objects and do not indicate a particular order or sequence. It should be understood that the terms can be interchanged in appropriate cases, so that the embodiments of the disclosure can be practiced in an order other than those illustrated or described herein. The embodiments described in the following exemplary embodiments do not represent all embodiments consistent with the disclosure. Instead, they are only examples of devices and methods consistent with some aspects of the disclosure as described in detail in the appended claims.

FIG. 1 is a schematic diagram of an application environment of a method for processing an emoji message according to an embodiment of the disclosure. The application environment may include a terminal 11 and a server 12 that are connected to each other via a wireless network.

The terminal 11 may be a smartphone, a tablet computer, a laptop computer, a desktop computer, etc., but is not limited thereto. The terminal 11 is installed with client software that provides a human-computer interaction function, such as an Application (App). The App may be an independent App or a sub-program within an App. For example, the App may be a short video App or an IM App.

The server 12 may be a server that provides back-end services for Apps in the terminal 11. The server 12 may be an independent physical server, or a server cluster or a distributed system consisting of a plurality of physical servers.

Those skilled in the art may know that the number of the above terminals may be only one, or dozens or hundreds, or even more. The number of terminals and the device type are not limited in the embodiments of the disclosure.

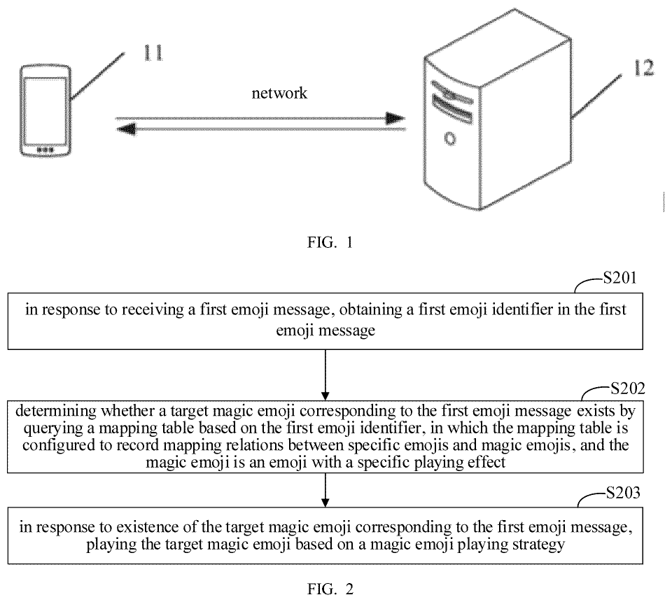

FIG. 2 is a flowchart of a method for processing an emoji message according to an embodiment of the disclosure. The method for processing an emoji message can be applied to the terminal 11 illustrated in FIG. 1. As illustrated in FIG. 2, the method for processing an emoji message includes the following blocks.

At block S201, in response to receiving a first emoji message, a first emoji identifier in the first emoji message is obtained.

An emoji identifier is configured to identify an emoji uniquely. The emoji identifier can be an emoji ID.

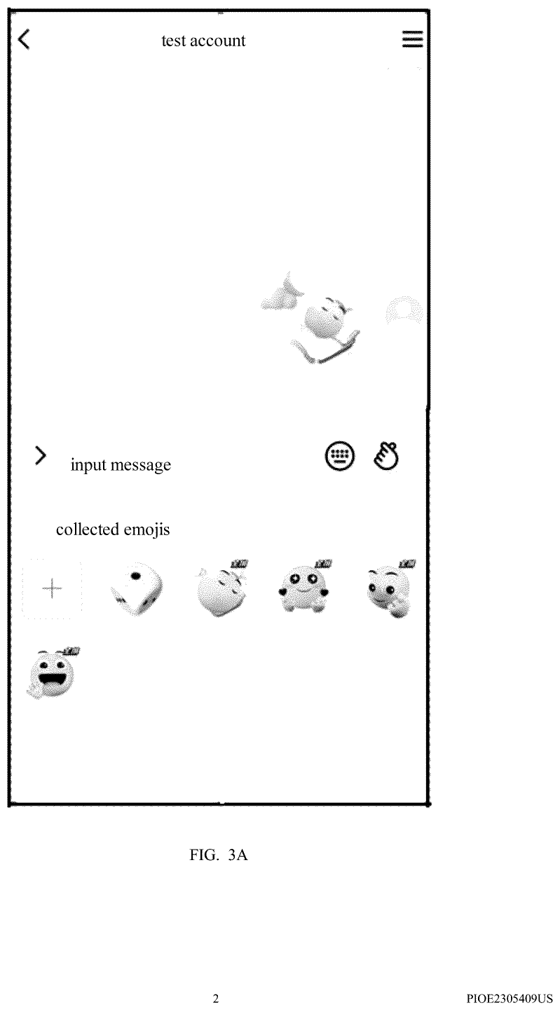

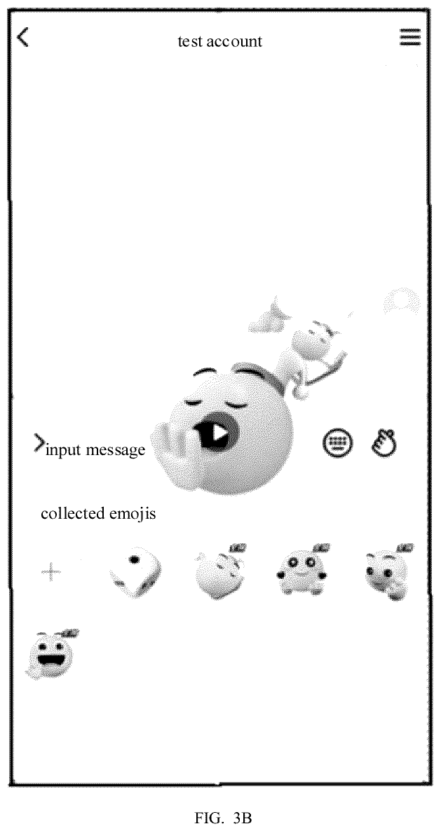

For example, the method for processing an emoji message is applied to an IM APP in a mobile phone, as illustrated in FIG. 3A, a user A receives a message 1, which is an emoji message, and a corresponding emoji is displayed on a display interface of the IM APP of the user A.

At block S202, it is determined whether a target magic emoji corresponding to the first emoji message exists by querying a mapping table based on the first emoji identifier.

The mapping table is configured to record mapping relations between specific emojis and magic emojis. The specific emoji is an emoji that may trigger a magic emoji. The mapping table can record specific emoji IDs and magic emoji IDs. The mapping table can be stored in the server and sent to a client when the user opens the IM software. When the mapping table on the server side is changed, the updated mapping table can be sent to the client in time.

In an optional embodiment, the mapping table is shown in Table 1 below:

TABLE 1

| magic emoji | specific emoji |
|---|---|
| non-synthetic magic emoji 1 | emoji 1 |
| non-synthetic magic emoji 2 | emoji 2 |
| synthetic magic emoji 1 | emoji 1, emoji 1 |
| synthetic magic emoji 2 | emoji 3, emoji 4 |

If the user receives an emoji message while chatting, the emoji message needs to be processed according to a certain rule. Only some specific emojis can trigger dynamic effects of magic emojis. The specific emojis that can trigger the dynamic effects of the magic emojis and the corresponding magic emojis are recorded to form the mapping table. When it is necessary to modify a specific emoji that can trigger the dynamic effect of a magic emoji or the corresponding magic emoji, changes can be made in the mapping table, which is easy to maintain. Compared to the technical solutions that couple the magic emoji information with the emoji information, this solution reduces the maintenance cost and improves the flexibility.

At this step, the mapping table is queried to determine whether the first emoji identifier exists in the mapping table, if the first emoji identifier exists in the mapping table, it means that the emoji message can trigger the dynamic effect of a magic emoji. If the first emoji identifier does not exist in the mapping table, it means that the emoji message cannot trigger the dynamic effect of a magic emoji.

At block S203, in response to existence of the target magic emoji corresponding to the first emoji message, the target magic emoji is played based on a magic emoji playing strategy.

The magic emoji playing strategy may include playing rules for different magic emojis. The playing orders or playing priorities of different magic emojis are defined by the magic emoji playing strategy, such as playing immediately, adding to a to-be-played queue, or not playing. In an alternative embodiment, the magic emojis may be classified, and the playing rules for different types of magic emojis may be set to form the magic emoji playing strategy.

On the basis of the above example, when the terminal of the user A queries the mapping table based on the identifier of the emoji message 1 and determines that there is a magic emoji corresponding to the emoji message 1. If it is determined that the magic emoji corresponding to the emoji message 1 needs to be played immediately according to the magic emoji playing strategy, the magic emoji is played on the display interface of the IM APP of the user A, as illustrated in FIG. 3B.

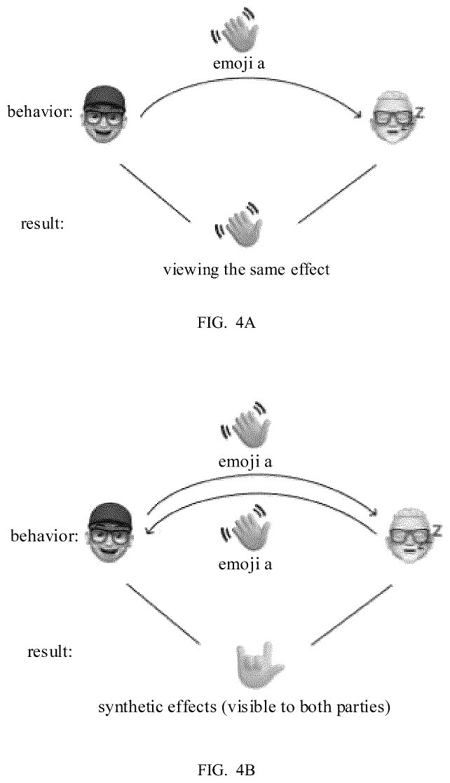

In an alternative embodiment, the magic emojis are classified as non-synthetic magic emoji and synthetic magic emoji. The non-Synthetic magic emoji is triggered by a specific emoji. As illustrated in FIG. 4A, the user a sends a specific emoji (e.g., emoji 1 in Table 1) to a user b, which triggers a non-synthetic magic emoji (e.g., non-synthetic magic emoji 1 in Table 1). Triggering of the synthetic magic emoji requires two or more users to send the same specific emoji or different specific emojis within a certain period of time. As illustrated in FIG. 4B, the user a and the user b both send an emoji a to each other within a certain period of time, which triggers a synthetic magic emoji.

Since synthesizing the magic emoji requires two or more users to send a specific emoji mutually, which is done by more than two people, the magic emoji playing strategy can be set as follows, in order to increase the intimacy between users and improve the user experience and viscosity.

1. A synthetic magic emoji can interrupt playing of a non-synthetic magic emoji, and a non-synthetic magic emoji cannot interrupt playing of a synthetic magic emoji.

2. Magic emojis of the same type cannot interrupt each other, i.e. a synthetic magic emoji cannot interrupt playing of another synthetic magic emoji, and a non-synthetic magic emoji cannot interrupt playing of another non-synthetic magic emoji.

If there is a target magic emoji corresponding to the first emoji message, according to the magic emoji playing strategy, a playing rule for the target magic emoji is determined, such as whether to play the target magic emoji immediately, whether to add the magic emoji to the to-be-played queue or to discard the target magic emoji.

The method for processing an emoji message decouples the emoji information and the magic emoji information based on the mapping table for recording the mapping relations between the specific emojis and the magic emojis, which is easy to maintain, thereby reducing the maintenance cost. After receiving the first emoji message, the first emoji identifier in the first emoji message is obtained. It is determined whether there is the target magic emoji corresponding to the first emoji message by querying the mapping table based on the first emoji identifier. If there is the target magic emoji corresponding to the first emoji message, the target magic emoji is played based on the magic emoji playing strategy, which is able to meet a playing requirement of different types of magic emojis, thereby improving the user experience and improving the user viscosity.

In an alternative embodiment, as illustrated in FIG. 5, block S203 includes the following blocks.

At block S501, in response to existence of the target magic emoji corresponding to the first emoji message, a magic emoji to-be-played task is created, and a priority of the magic emoji to-be-played task is determined.

At block S502, the target magic emoji is played based on the priority of the magic emoji to-be-played task.

In the embodiment, if there is the target magic emoji corresponding to the first emoji message, the magic emoji to-be-played task is created and the priority of the magic emoji to-be-played task (hereinafter referred to as to-be-played task) is determined. The priority of the to-be-played task can be determined based on a type of the target magic emoji. For example, if the target magic emoji is a synthetic magic emoji, the priority of the to-be-played task is high, and if the target magic emoji is a non-synthetic magic emoji, the priority of the to-be-played task is low. By defining the task corresponding to the relatively complex synthetic magic emoji as having a high priority, and the task corresponding to the relatively simple non-synthetic magic emoji as having a low priority, it is ensured that a complex synthetic magic emoji is prioritized over a non-synthetic magic emoji, so that the user can be satisfied to watch the complex magic emoji produced with the user's participation, which enhances the user experience.

Whether the target magic emoji is a synthetic magic emoji or a non-synthetic magic emoji needs to be determined in combination with an emoji message sent last time or next time. For example, after determining that a synthetic magic emoji and a non-synthetic magic emoji corresponding to the first emoji identifier exist in the mapping table, a second emoji identifier of a second emoji message is obtained. Based on the first emoji identifier of the first emoji message and the second emoji identifier of the second emoji message, a type of the magic emoji is determined. A time difference between a sending time of the second emoji message and a receiving time of the first emoji message is within a certain range. The second emoji message may be an emoji message sent before the first emoji message is received or an emoji message sent after the first emoji message is received. After obtaining the second emoji identifier, it is determined whether a synthetic magic emoji corresponding to the first emoji identifier and the second emoji identifier exists. If the synthetic magic emoji exists, the target magic emoji is determined as the synthetic magic emoji, and the to-be-played task has a high priority. If the synthetic magic emoji does not exist, the target magic emoji is determined as a non-synthetic magic emoji corresponding to the first emoji identifier, and the to-be-played task has a low priority. The type of the magic emoji is determined, i.e., whether the magic emoji is a synthetic magic emoji or a non-synthetic magic emoji is determined, based on the received emoji message in combination with the sent emoji, so that the type and complexity of the magic emoji can be accurately determined and its priority can be determined.

After determining the priority of the to-be-played task, how to play the target magic emoji can be determined based on the priority of the to-be-played task. For example, if the to-be-played task has a high priority, the currently played task having a low priority can be interrupted. If the to-be-played task has a low priority, the currently played task having a high priority cannot be interrupted.

In an alternative embodiment, the method for processing an emoji message further includes: determining whether a magic emoji is currently played: in response to not playing a magic emoji currently, playing the target magic emoji directly; and in response to playing a magic emoji currently, playing the target magic emoji based on the priority of the magic emoji to-be-played task and a priority of a task corresponding to the currently played magic emoji. That is, based on the priority of the to-be-played task and the priority corresponding to the task of the currently played magic emoji, it is determined whether to play the target magic emoji immediately, or to add it to the to-be-played queue and play it after playing of the currently played magic emoji completes, or not to play the target magic emoji.

For example, if the priority of the to-be-played task is higher than the priority corresponding to the task of the currently played magic emoji, the currently played magic emoji is interrupted, and the to-be-played task is directly executed to play the target magic emoji. If the priority of the to-be-played task is the same as the priority corresponding to the task of the currently played magic emoji, the target magic emoji is played after playing of the current magic emoji completes.

The priority of the to-be-played task being higher than the priority corresponding to the task of the currently played magic emoji may include the priority of the to-be-played task being a high priority and the priority corresponding to the task of the currently played magic emoji being a low priority. The priority of the to-be-played task being the same as the priority corresponding to the task of the currently played magic emoji may include both the priority of the to-be-played task and the priority corresponding to the task of the currently played magic emoji being high, or, both the priority of the to-be-played task and the priority corresponding to the task of the currently played magic emoji being low. The priority of the to-be-played task being lower than the priority corresponding to the task of the currently played magic emoji may include the priority of the to-be-played task being a low priority and the priority corresponding to the task of the currently played magic emoji being a high priority.

In the case that a magic emoji is currently being played, by comparing the priority of the task corresponding to the currently played magic emoji with the priority of the to-be-played task, the need to play the task with a high priority can be satisfied, so that the user experience can be improved.

In an alternative embodiment, to further ensure that the playing of the synthetic magic emoji is prioritized, the method further includes: in response to playing the magic emoji currently, determining whether the priority of the magic emoji to-be-played task satisfies a playing condition; in response to the priority of the magic emoji to-be-played task satisfying the playing condition, playing the target magic emoji based on the priority of the magic emoji to-be-played task and the priority of the task corresponding to the currently played magic emoji: in response to the priority of the magic emoji to-be-played task not satisfying the playing condition, discarding the magic emoji to-be-played task. The playing condition is configured to define the magic emoji that can be played. For example, the priority of the task may be classified as a high priority and a low priority, the task with the high priority is prioritized over the task with the low priority. The priority of the magic emoji to-be-played task satisfying the playing condition may refer to that the priority of the magic emoji to-be-played task is the high priority. If the priority of the to-be-played task is the high priority, the target magic emoji is played after playing of the currently played magic emoji completes, and if the priority of the to-be-played task is the low priority, the to-be-played task is discarded and the target magic emoji will not be played.

In an alternative embodiment, while waiting for the completion of playing the currently played magic emoji, the to-be-played task can be added to the to-be-played queue. After playing of the currently played magic emoji completes, the tasks in the to-be-played queue are executed according to the order of tasks within the queue and the corresponding magic emojis are played correspondingly.

In an alternative embodiment, the capacity of the to-be-played queue may be limited. That is, the number of magic emoji to-be-played tasks in the to-be-played queue may be determined. In response to the number of magic emoji to-be-played tasks in the to-be-played queue being greater than or equal to a threshold, a task to be discarded in the to-be-played queue can be determined, and the task to be discarded is discarded. For example, when the number of to-be-played tasks in the to-be-played queue is greater than or equal to the threshold, the task in the to-be-played queue that enters the to-be-played queue at the earliest time in accordance with a time sequence, i.e., the to-be-played task at the head of the to-be-played queue, is discarded. The threshold may be set flexibly, which is not limited in the disclosure.

By limiting the capacity of the to-be-played queue in the embodiment, the latest, high-priority magic emoji can be played in a timely manner on the one hand, and storage space can be saved and a storage cost can be reduced on the other hand.

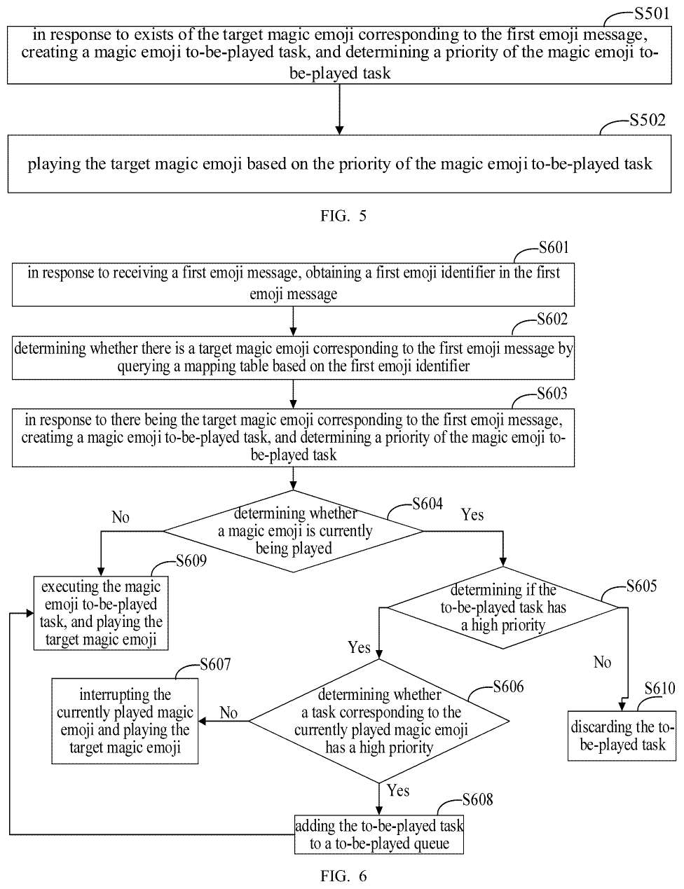

FIG. 6 is a flowchart of the method for processing an emoji message according to another embodiment of the disclosure. In the method of the embodiment, the magic emoji playing strategy is provided as follows. (1) A priority of a task corresponding to a non-synthetic magic emoji is set to a low priority, and a priority of a task corresponding to a synthetic magic emoji is set to a high priority. (2) A task with the low priority can't interrupt a task with the high priority, a high priority task can interrupt a low priority task, and tasks with the same priority cannot interrupt each other. (3) Only tasks with the high priority are kept in a to-be-played queue, and tasks with the low priority are not reserved. Based on the magic emoji playing strategy, as illustrated in FIG. 6, the method of the embodiment includes the following blocks.

At block S601, in response to receiving a first emoji message, a first emoji identifier in the first emoji message is obtained.

At block S602, it is determined whether there is a target magic emoji corresponding to the first emoji message by querying a mapping table based on the first emoji identifier.

At block S603, in response to there being the target magic emoji corresponding to the first emoji message, a magic emoji to-be-played task is created, and a priority of the magic emoji to-be-played task is determined.

At block S604, it is determined whether a magic emoji is currently being displayed.

At block S605, in response to playing a magic emoji currently, it is determined whether the priority of the magic emoji to-be-played task is a high priority.

At block S606, in response to the priority of the magic emoji to-be-played task being a high priority, it is determined whether a priority of a task corresponding to the currently played magic emoji is a high priority.

At block S607, in response to the priority of the task corresponding to the currently played magic emoji being a low priority, the currently played magic emoji is interrupted, the magic emoji to-be-played task is executed, and the target magic emoji is played.

At block S608, in response to the priority of the task corresponding to the currently played magic emoji being a high priority, the magic emoji to-be-played task is added to a to-be-played queue.

At block S609, after playing of the currently played magic emoji completes, tasks in the to-be-played queue are executed, and corresponding magic emojis are played.

At block S610, in response to the priority of the magic emoji to-be-played task being a low priority, the magic emoji to-be-played task is discarded.

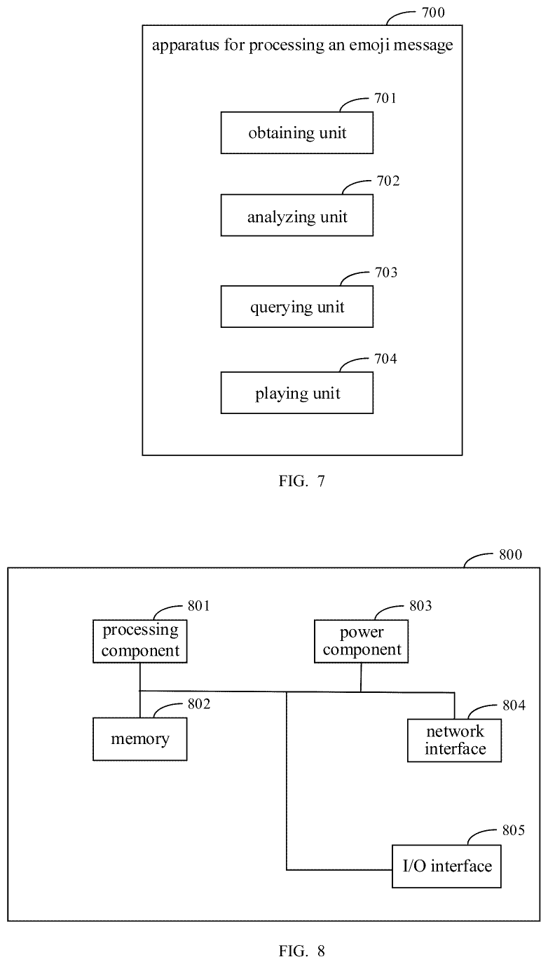

FIG. 7 is a block diagram of an apparatus 700 for processing an emoji message according to an embodiment of the disclosure. As illustrated in FIG. 7, the apparatus 700 includes:
an analyzing unit 701, configured to, in response to receiving a first emoji message, obtain a first emoji identifier in the first emoji message;
a querying unit 702, configured to determine whether a target magic emoji corresponding to the first emoji message exists by querying a mapping table based on the first emoji identifier, in which the mapping table is configured to record mapping relations between specific emojis and magic emojis, and the magic emoji is an emoji with a specific playing effect; and
a playing unit 703, configured to, in response to existence of the target magic emoji corresponding to the first emoji message, play the target magic emoji based on a magic emoji playing strategy.

In an alternative embodiment of the disclosure, the playing unit is further configured to: in response to existence of the target magic emoji corresponding to the first emoji message, create a magic emoji to-be-played task, and determine a priority of the magic emoji to-be-played task; and play the target magic emoji based on the priority of the magic emoji to-be-played task.

In an alternative embodiment of the disclosure, the playing unit is further configured to: determine whether a magic emoji is currently played: in response to not playing the magic emoji currently, execute the magic emoji to-be-played task directly, and play the target magic emoji; and in response to playing the magic emoji currently, play the target magic emoji based on the priority of the magic emoji to-be-played task and a priority of a task corresponding to the currently played magic emoji.

In an alternative embodiment of the disclosure, the playing unit is further configured to: in response to playing the magic emoji currently, determine whether the priority of the magic emoji to-be-played task satisfies a playing condition: in response to the priority of the magic emoji to-be-played task satisfying the playing condition, play the target magic emoji based on the priority of the magic emoji to-be-played task and the priority of the task corresponding to the currently played magic emoji; and in response to the priority of the magic emoji to-be-played task not satisfying the playing condition, discard the magic emoji display task.

In an alternative embodiment of the disclosure, the playing unit is further configured to: in response to the priority of the magic emoji to-be-played task being higher than the priority of the task corresponding to the currently played magic emoji, interrupt the currently played magic emoji, execute the magic emoji to-be-played task, and play the target magic emoji.

In an alternative embodiment of the disclosure, the playing unit is further configured to: in response to the priority of the magic emoji to-be-played task being equal to the priority of the task corresponding to the currently played magic emoji, add the magic emoji to-be-played task to a to-be-played queue; and execute the magic emoji to-be-played task in the to-be-played queue after playing of the currently played magic emoji completes.

In an alternative embodiment of the disclosure, the playing unit is further configured to: obtain a second emoji identifier of a second emoji message; and determine a type of the target magic emoji based on the first emoji identifier of the first emoji message and the second emoji identifier of the second emoji message.

In an alternative embodiment of the disclosure, the playing unit is further configured to: determine a number of magic emoji to-be-played tasks in the to-be-played queue; and in response to the number of magic emoji to-be-played tasks in the to-be-played queue being greater than or equal to a threshold, determine a task to be discarded in the to-be-played queue, and discard the task to be discarded.

With regard to the apparatus in the above embodiments, the specific manner in which each unit performs an operation has been described in detail in the method embodiments, and will not be described in detail here.

FIG. 8 is a schematic diagram of an electronic device (e.g., a server) according to an embodiment of the disclosure. As illustrated in FIG. 8, the server 800 includes a processing component 801 including one or more processors, and memory resources represented by a memory 802 for storing instructions that can be executed by the processing component 801, such as APPs. The APPs stored in the memory 802 may include one or more units each corresponding to a set of instructions. In addition, the processing component 801 is configured to execute the instructions to implement the method for processing an emoji message described above.

The server 800 may also include a power component 803 configured to perform power management of the server 800, a wired or wireless network interface 804 configured to connect the server 800 to a network, and an Input/Output (I/O) interface 805. The server 800 may operate on an operating system stored in the memory 802, such as Windows Server™, Mac OS X™, Unix™, Linux™, FreeBSD™, or the like.

In an exemplary embodiment, a storage medium having instructions stored thereon is provided. When the instructions are executed by a processor of a server, the server is caused to implement the above method for processing an emoji message. Optionally, the storage medium may be a non-transitory computer-readable storage medium. For example, the non-transitory computer-readable storage medium may be a read only memory (ROM), a random access memory (RAM), a CD-ROM, a magnetic tape, a floppy disk, and an optical data storage device.

In an embodiment, a computer program product having readable program codes stored thereon is provided. When the readable program codes are executed by a processor of a server, the server is caused to implement the above method for processing an emoji message. Optionally, the program codes may be stored in a storage medium of a terminal or a server. The storage medium may be a non-transitory computer-readable storage medium. For example, the non-transitory computer-readable storage medium may be a ROM, a RAM, a CD-ROM, a magnetic tape, a floppy disk, and an optical data storage device.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims. It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

1. A method for processing an emoji message, performed by an electronic device, comprising:
obtaining a first emoji identifier in a first emoji message in response to receiving the first emoji message;
determining whether a target first-type emoji corresponding to the first emoji message exists by querying a mapping table based on the first emoji identifier, wherein the mapping table is configured to record mapping relations between second-type emojis and first-type emojis, and the first-type emoji is an emoji with a specific playing effect, and the second-type emoji is an emoji capable of triggering at least one first-type emoji; and
playing the target first-type emoji based on a playing strategy in response to existence of the target first-type emoji corresponding to the first emoji message.

2. The method of claim 1, wherein playing the target first-type emoji based on the playing strategy in response to existence of the target first-type emoji corresponding to the first emoji message, comprises:
in response to existence of the target first-type emoji corresponding to the first emoji message, creating a to-be-played task, and determining a first priority of the to-be-played task; and
playing the target first-type emoji based on the priority of the to-be-played task.

3. The method of claim 2, wherein playing the target first-type emoji based on the first priority of the to-be-played task, comprises:
determining whether a first-type emoji is played currently;
in response to not playing the first-type emoji currently, executing the to-be-played task, and playing the target first-type emoji; and
in response to playing the first-type emoji currently, playing the target first-type emoji based on the first priority and a second priority of a task corresponding to the currently played first-type emoji.

4. The method of claim 3, wherein in response to playing the first-type emoji currently, playing the target first-type emoji based on the first priority and the second priority of the task corresponding to the currently played first-type emoji, comprises:
in response to playing the first-type emoji currently, determining whether the first priority satisfies a playing condition;
in response to the first priority satisfying the playing condition, playing the target first-type emoji based on the first priority and the second priority;
in response to the first priority not satisfying the playing condition, discarding the to-be-played task.

5. The method of claim 4, wherein in response to the first priority satisfying the playing condition, playing the target first-type emoji based on the first priority and the second priority, comprises:
in response to the first priority being higher than the second priority, interrupting the currently played first-type emoji, executing the to-be-played task, and playing the target first-type emoji.

6. The method of claim 4, wherein in response to the first priority satisfying the playing condition, playing the target first-type emoji based on the first priority and the second priority, comprises:
in response to the first priority being equal to the second priority, adding the to-be-played task to a to-be-played queue; and
executing the to-be-played task in the to-be-played queue after playing of the currently played first-type emoji completes.

7. The method of claim 2, wherein determining the first priority of the to-be-played task, comprises:
determining the first priority based on a type of the target first-type emoji.

8. The method of claim 7, further comprising:
obtaining a second emoji identifier of a second emoji message;
determining the type of the target first-type emoji based on the first emoji identifier and the second emoji identifier.

9. The method of claim 8, wherein determining the type of the target first-type emoji based on the first emoji identifier and the second emoji identifier comprises:
determining the target first-type emoji as a synthetic first-type emoji, in response to the synthetic first-type emoji corresponding to the first emoji identifier and the second emoji identifier existing in the mapping table, wherein the synthetic first-type emoji is triggered by two or more second-type emojis;
determining the target first-type emoji as a non-synthetic first-type emoji corresponding to the first emoji identifier, in response to no synthetic first-type emoji corresponding to the first emoji identifier and the second emoji identifier existing in the mapping table, wherein the non-synthetic first-type emoji is triggered by one second-type emoji.

10. The method of claim 8, wherein second emoji message is sent by the electronic device, and a time difference between a sending time of the second emoji message and a receiving time of the first emoji message is within a predetermined range.

11. The method of claim 7, wherein the type of the target first-type emoji comprises a synthetic first-type emoji triggered by two or more second-type emojis and a non-synthetic first-type emoji triggered by one second-type emoji, and a priority of a task corresponding to the synthetic first-type emoji is higher than a priority of a task corresponding to the non-synthetic first-type emoji.

12. The method of claim 6, further comprising:
determining a number of to-be-played tasks in the to-be-played queue; and
in response to the number of to-be-played tasks being greater than or equal to a threshold, determining a task to be discarded in the to-be-played queue, and discarding the task to be discarded.

13. An electronic device, comprising:
a processor;
a memory for storing instructions executable by the processor: wherein
the processor is configured to execute the instructions to implement the following operations;
obtaining a first emoji identifier in a first emoji message in response to receiving the first emoji message;
determining whether a target first-type emoji corresponding to the first emoji message exists by querying a mapping table based on the first emoji identifier, wherein the mapping table is configured to record mapping relations between second-type emojis and first-type emojis, and the first-type emoji is an emoji with a specific playing effect, and the second-type emoji is an emoji capable of triggering at least one first-type emoji; and
playing the target first-type emoji based on a playing strategy in response to existence of the target first-type emoji corresponding to the first emoji message.

14. The electronic device of claim 13, wherein playing the target first-type emoji based on the playing strategy in response to existence of the target first-type emoji corresponding to the first emoji message, comprises:
in response to existence of the target first-type emoji corresponding to the first emoji message, creating a to-be-played task, and determining a first priority of the to-be-played task; and
playing the target first-type emoji based on the priority of the to-be-played task.

15. The electronic device of claim 14, wherein playing the target first-type emoji based on the first priority of the to-be-played task, comprises:
determining whether a first-type emoji is played currently;
in response to not playing the first-type emoji currently, executing the to-be-played task, and playing the target first-type emoji; and
in response to playing the first-type emoji currently, playing the target first-type emoji based on the first priority and a second priority of a task corresponding to the currently played first-type emoji.

16. The electronic device of claim 15, wherein in response to playing the first-type emoji currently, playing the target first-type emoji based on the first priority and the second priority of the task corresponding to the currently played first-type emoji, comprises:
in response to playing the first-type emoji currently, determining whether the first priority satisfies a playing condition;
in response to the first priority satisfying the playing condition, playing the target first-type emoji based on the first priority and the second priority;
in response to the first priority not satisfying the playing condition, discarding the to-be-played task.

17. The electronic device of claim 16, wherein in response to the first priority satisfying the playing condition, playing the target first-type emoji based on the first priority and the second priority, comprises:
in response to the first priority being higher than the second priority, interrupting the currently played first-type emoji, executing the to-be-played task, and playing the target first-type emoji.

18. The electronic device of claim 17, wherein in response to the first priority satisfying the playing condition, playing the target first-type emoji based on the first priority and the second priority, comprises:
in response to the first priority being equal to the second priority, adding the to-be-played task to a to-be-played queue; and
executing the to-be-played task in the to-be-played queue after playing of the currently played first-type emoji completes.

19. The electronic device of claim 14, wherein determining the first priority of the to-be-played task, comprises:
determining the first priority based on a type of the target first-type emoji.

20. A non-transitory computer-readable storage medium having at least one computer program stored thereon, wherein when the at least one computer program is loaded and executed by a processor, the processor is caused to implement the following operations:
obtaining a first emoji identifier in a first emoji message in response to receiving the first emoji message;
determining whether a target first-type emoji corresponding to the first emoji message exists by querying a mapping table based on the first emoji identifier, wherein the mapping table is configured to record mapping relations between second-type emojis and first-type emojis, and the first-type emoji is an emoji with a specific playing effect, and the second-type emoji is an emoji capable of triggering at least one first-type emoji; and
playing the target first-type emoji based on a playing strategy in response to existence of the target first-type emoji corresponding to the first emoji message.
